(19) United States
(12) Patent Application Publication
(10) Pub. No.: US 2008/0066091 A1
(43) Pub. Date: Mar. 13, 2008

(54) METHODS, SYSTEMS, AND COMPUTER PROGRAM PRODUCTS FOR PROVIDING CONTENT PREVIEW SERVICES

(75) Inventors: John Stefanik, Atlanta, GA (US); Phillip Weeks, Atlanta, GA (US); Charles P. Bradley, Lawrenceville, GA (US); E-Lee Chang, Mableton, GA (US); Tuck Seng Tan, Lawrenceville, GA (US); Kitt Tucker, Alpharetta, GA (US)

Correspondence Address: CANTOR COLBURN LLP - BELLSOUTH, 20 Church Street, 22nd Floor, Hartford, CT, 06103, US

(73) Assignee: BellSouth Intellectual Property Corporation, Wilmington, DE (US)

(21) Appl. No.: 11/467,696

(22) Filed: Aug. 28, 2006

(51) Int. Cl. H04N 5/445; H04N 5/45; H04N 7/16; G06F 3/00; G06F 13/00

(52) U.S. Cl. 725/8; 348/565; 725/39; 725/40; 725/41

(57) ABSTRACT

A method, system, and computer program product for providing content previewing services is provided. The method includes associating a content preview with a program descriptor that identifies a program in an onscreen programming guide database of programming content listings. The method also includes presenting the content preview to a program receiving device responsive to selection of the program descriptor. The content preview provides information about the program.

### BACKGROUND OF THE INVENTION

The present invention relates generally to Internet Protocol (IP)-based programming services, and more particularly, to methods, systems, and computer program products for providing content preview services.

Current onscreen programming guides (OPG) display current and future television programs by title, and in some instances provide textual descriptions of the program within a display panel at a content device. This textual information provides a brief summary (e.g., typically one or two sentences) about the program and, because of its one-dimensional and somewhat insipid presentation, may not be particularly useful to content viewers when selecting from a variety of viewing alternatives. On the other hand, other forms of programming information, e.g., commercials, movie trailers, etc. are oftentimes more influential in persuading viewers to watch a particular program. These other forms of programming information typically provide more detail and insight regarding programming content, which in turn, assists viewers in selecting desired content for viewing. However, commercials are not necessarily presented to a viewing audience at the optimal time for attracting viewers to a program, i.e., when the viewers are making their viewing selections (e.g., via an onscreen programming guide).

What is needed, therefore, is a way to present content previews for programming content within an onscreen programming guide that provides a sufficient amount of programming information in order to assist viewers in selecting from various content viewing alternatives.

### BRIEF SUMMARY OF THE INVENTION

Exemplary embodiments include a method, system, and computer program device for providing content previewing services. The method includes associating a content preview with a program descriptor that identifies a program in an onscreen programming guide database of programming content listings. The method also includes presenting the content preview to a program receiving device responsive to selection of the program descriptor. The content preview provides information about the program.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram depicting a system upon which content preview services may be implemented in exemplary embodiments;

FIG. 2 is a flow diagram describing a process for implementing the content preview services in exemplary embodiments; and

FIG. 3 depicts a database record with sample data relating to a program including content preview capabilities, the database record utilized in implementing the content preview services in exemplary embodiments.

The detailed description explains the exemplary embodiments, together with advantages and features, by way of example with reference to the drawings.

### DETAILED DESCRIPTION OF EXEMPLARY EMBODIMENTS

Content preview services are provided for presenting descriptive information about current and/or future programming within an onscreen programming guide. Content previews may include static images, audio, video, and/or multi-media elements.

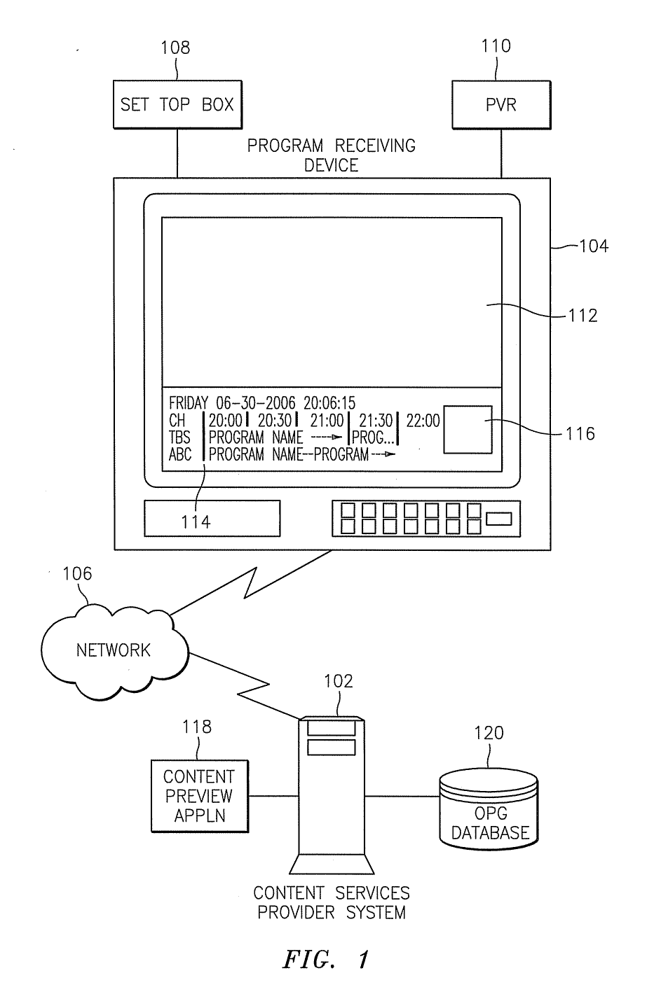

Turning now to FIG. 1, a system upon which the content preview services may be implemented in accordance with exemplary embodiments will now be described. The system of FIG. 1 includes a content services provider system 102 in communication with a program receiving device 104 via a network 106. The content services provider system 102 facilitates the content preview services described herein.

In exemplary embodiments, content services provider system 102 is implemented by a host system (e.g., a high-speed processing device) that provides content to its customers (e.g., a user of program receiving device 104), such as television programs, premium programming services, video on demand content, and Internet/Web content (e.g., podcasts, streaming media, etc.), to name a few. In exemplary embodiments, this content is transmitted to customers via a broadband connection over an Internet Protocol (IP)-based network (e.g., network 106). Content services provider system 102 also provides an onscreen programming guide to customers (e.g., user of program receiving device 104) that provides information about current and future programming available via the content providers' services. Programming information provided by the onscreen programming guide may include current and future program listings including program titles, primary actors/actresses, begin time, duration of program, a year in which the program was produced, and a brief text description of the program.

In exemplary embodiments, content services provider system 102 also provides picture-in-picture (PIP) services via, e.g., the broadband connection over IP-based network 106. Picture-in-picture services enable viewers to simultaneously view two currently showing programs, one program shown in a PIP panel of the program receiving device 104 and one program shown in a primary panel (e.g., a large panel) of the program receiving device 104. In alternative embodiments, some of the PIP functionality may be implemented at the program receiving device 104.

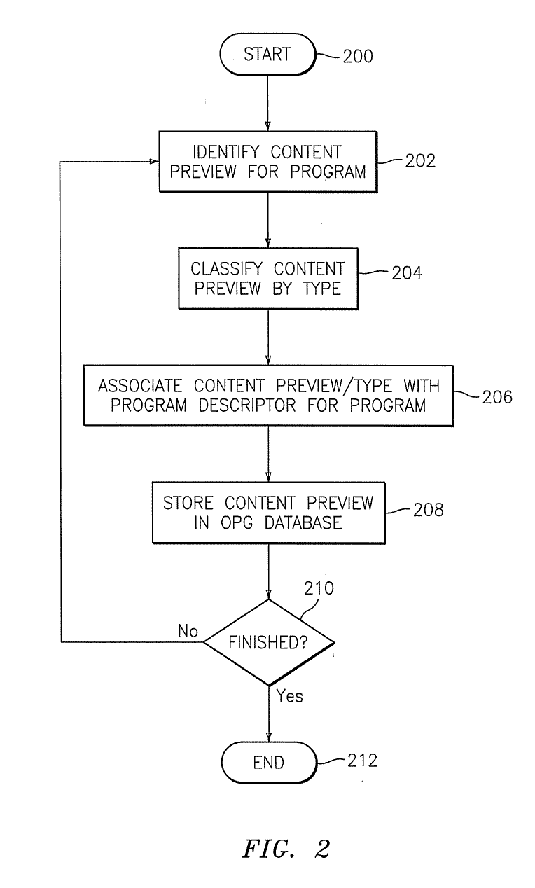

In exemplary embodiments, content services provider system 102 executes an application for implementing the content preview services described herein. This application is referred to as content preview application 118. The content preview application 118 and onscreen programming services may be implemented as a single program executing on the content services provider system 102, or may be separate physical components that interact via, e.g., an application programming interface or other technique. In alternative exemplary embodiments, the content preview application 118 may execute locally on program receiving device 104. The functionality of the content preview services provided via the content preview application 118 will be described further in FIG. 2.

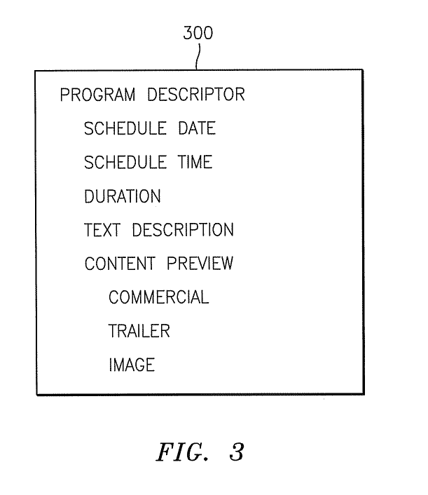

Also included in the system of FIG. 1 is a storage device 120 that is communicatively coupled to the content services provider system 102 (e.g., via physical cabling or wireless means). Additionally, the storage device 120 may be in communication with content services provider system 102 via one or more networks (e.g., network 106). Storage device 120 may store programming content, as well as programming schedules for the content (e.g., onscreen programming guide information). In exemplary embodiments, the storage device 120 stores records of programming events scheduled for transmission to customers, such as program receiving device 104. These records, in turn, include content preview information that is utilized by the content preview application 118 as described further herein. A sample program record 300 is shown and described in FIG. 3.

In accordance with exemplary embodiments, network 106 is an IP-based network that transmits programming content from content services provider system 102 to customers, such as program receiving device 104 via a broadband connection. Network 106 may be implemented in a wireless fashion, e.g., using wireless protocols and technologies, such as WiFi, WiMax, etc.

Program receiving device 104 presents programming content for viewing to users of the content preview services. Program receiving device 104 may be any type of network-enabled device that is capable of presenting programming content to viewers. In exemplary embodiments, program receiving device 104 may be a high-definition television, a personal computer, a portable computing device (e.g., personal digital assistant), a digital music player (e.g., MP3 player), cellular telephone (e.g., a 3 G cell phone), etc.

Program receiving device 104 may include auxiliary devices, such as a set top box 108, personal video record (PVR) 110, and a remote control (not shown). Set top box 108 provides a connection between the program receiving device 102 and external sources of signals, converting the signals into content that is displayed on a screen of the device 104. Where program receiving device 104 is an IP-enabled television, or IPTV device, set top box 108 includes a computer that provides bi-directional communications between network 106 and the program receiving device 104 and decodes the video streaming media received as content programming and onscreen programming information from content services provider system 102. The remote control may include options (e.g., interface) enabled by the onscreen programming guide services for selecting content previews for display.

A personal video recorder (PVR) 110 may be communicatively coupled to program receiving device 104 and records programming as configured by a user of the program receiving device 104.

As indicated above, program receiving device 104 includes a display screen for viewing content provided by the content services provider system 102. The display screen includes a primary panel 112 that displays current program content that has been selected by a viewer. Current program content refers to programming that is scheduled to air, and is presented at a designated time, as provided in the onscreen programming guide. The display screen of program receiving device 104 also includes an onscreen programming guide panel 114 that provides information relating to current and future programming. As indicated above, the type of information that may be provided via the onscreen programming guide, and displayed on onscreen programming guide panel 114, includes program titles, primary actors/actresses, begin time, duration of program, a year in which the program was produced, and a brief text description of the program selected by the viewer via the onscreen programming guide feature.

The display screen of program receiving device 104 also includes a content preview panel 116 that is presented by the content preview application 118 as described further herein. The content preview panel 116 may be implemented using the PIP functionality enabled by the content services provider system 102. Alternatively, or in addition, the content preview panel 116 may be implemented using a PIP feature provided via set top box 108 or as a PIP feature that is integrated into program receiving device 104. As shown in the system of FIG. 1 for illustrative purposes, the content preview panel 116 is integrated with the programming information presented in the onscreen programming guide panel 114. However, it will be understood that the content preview panel 116 may be presented anywhere on the display screen of program receiving device 104 (e.g., within the primary panel 112 or an additional panel (not shown) that is separate from the primary panel 112 and the onscreen programming guide panel 114. The content preview application 118 receives content previews from a variety of content sources (e.g., motion picture industry, television networks, Internet-based content providers, etc.). Content previews may include a list of programs scheduled to be recorded by a personal video recorder (e.g., PVR 110) or a list of programs already recorded by a PVR. These content previews are associated with corresponding program content as described further in FIGS. 2 and 3.

Turning now to FIG. 2, a flow diagram describing a process for implementing the content preview services will now be described in exemplary embodiments. The process begins at step 200 whereby a content preview is identified for a program that is scheduled to air via the content services provider system 102 at step 202. As indicated above, the content preview may include a static image relating to the program, a movie trailer, a commercial, a sound bite, a content sample, a series of still images, or other item. In addition, the content preview may be in audio format, video format, a static image, or multi-media format.

At step 204, the content preview is classified according to its type. For example, a video content preview may be classified as “video”, an audio content preview may be classified as “audio”, etc. At step 206, the content preview and its type are associated with a program descriptor of the program. A program descriptor may include any type of information that uniquely identifies the program (e.g., program title, program identification, etc.). A record is created for the program and may include the onscreen programming guide information (e.g., program title, begin time, program duration, etc.). A sample record 300 is shown in FIG. 3. In addition, the record 300 includes content preview information that has been associated with the program descriptor. For example, the content preview information may be associated with the program descriptor by mapping corresponding data fields using a “key” or similar type of database implementation. The content preview is stored in the onscreen programming guide database in storage device 120 at step 208.

At step 210, it is determined whether a new content preview has been received at the content services provider system 102. If so, the process returns to step 202. Otherwise, the process ends at step 212.

As indicated above, the content previews presented may be provided within a PIP panel (e.g., content preview panel 116). The content preview application 118 may be configured such that the content preview panel, or PIP panel, is integrated with, and presented along with, the onscreen programming guide panel 114 (as shown in the system of FIG. 1).

Once a user selects a content preview via, e.g., selecting a program descriptor via a remote control option enabled by the onscreen programming guide services, the content preview is accessed by the content preview application 118 and presented within the content preview panel 116 of the display screen of program receiving device 104. The content preview application 118 may further include a feature that causes the program receiving device 104 to lower the volume of the content displayed on the primary panel 112 so that the audio emphasis is placed on the content preview in the content preview panel 116. In exemplary embodiments, the volume of the audio in the primary panel 112 is reduced to a level that is lower than the audio of the content preview presented in the content preview panel 116.

If a user of the program receiving device 104 selects a second content preview (e.g., via a second program descriptor), the content preview application 118 accesses the second content preview from the storage device 120 and replaces the first content preview with the second content preview within the content preview panel 116.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of providing content previewing services, comprising:
associating a content preview with a program descriptor that identifies a program in an onscreen programming guide database of programming content listings; and
presenting the content preview to a program receiving device responsive to selection of the program descriptor,
wherein the content preview provides information about the program.

2. The method of claim 1, further comprising:
associating the content preview with a picture-in-picture component of an onscreen programming guide, wherein the content preview is presented to the program receiving device as a picture-in-picture panel.

3. The method of claim 2, further comprising:
associating the content preview and the picture-in-picture component of the onscreen programming guide with a panel of the programming receiving device to enable the picture-in-picture panel to be displayed within the panel of the onscreen programming guide at the program receiving device.

4. The method of claim 2, further comprising:
providing audio with the content preview within the picture-in-picture panel; and
decreasing the volume of a program that is presented in a program viewing panel of the program receiving device, the volume of the program in the program viewing panel decreased to a level that is lower than the volume of the content preview.

5. The method of claim 2, further comprising:
updating content presented to the picture-in-picture panel to reflect selection of another program descriptor, the updated content including a content preview associated with the other program descriptor.

6. The method of claim 1, wherein the content preview is presented to a program receiving device that is Internet Protocol network-enabled and comprises at least one of a:
television;
personal computer;
personal digital assistant;
digital audio player; and
cellular telephone.

7. The method of claim 1, wherein the information about the program includes at least one of:
a commercial;
movie trailer;
static image;
sound bite;
content sample; and
a series of still images.

8. A system for providing content previewing services, comprising:
a content service provider host system; and
a content preview application executing on the host system, the content preview application performing a method, comprising:
associating a content preview with a program descriptor that identifies a program in an onscreen programming guide database of programming content listings; and
presenting the content preview to a program receiving device responsive to selection of the program descriptor;
wherein the content preview provides information about the program.

9. The system of claim 8, wherein the content preview application further performs:
associating the content preview with a picture-in-picture component of an onscreen programming guide, wherein the content preview is presented to the program receiving device as a picture-in-picture panel.

10. The system of claim 9, wherein the content preview application further performs:
associating the content preview and the picture-in-picture component of the onscreen programming guide with a panel of the programming receiving device to enable the picture-in-picture panel to be displayed within the panel of the onscreen programming guide at the program receiving device.

11. The system of claim 9, wherein the content preview application further performs:
providing audio with the content preview within the picture-in-picture panel; and
decreasing the volume of a program that is presented in a program viewing panel of the program receiving device, the volume of the program in the program viewing panel decreased to a level that is lower than the volume of the content preview.

12. The system of claim 9, wherein the content preview application further performs:
updating content presented to the picture-in-picture panel to reflect selection of another program descriptor, the updated content including a content preview associated with the other program descriptor.

13. The system of claim 8, wherein the content preview is presented to a program receiving device that is Internet Protocol network-enabled and comprises at least one of a:
television;
personal computer;
personal digital assistant;
digital audio player; and
cellular telephone.

14. A computer program product for providing content previewing services, the computer program product including instructions for implementing a method, comprising:
associating a content preview with a program descriptor that identifies a program in an onscreen programming guide database of programming content listings; and
presenting the content preview to a program receiving device responsive to selection of the program descriptor,
wherein the content preview provides information about the program.

15. The computer program product of claim 14, further comprising instructions for implementing:
associating the content preview with a picture-in-picture component of an onscreen programming guide, wherein the content preview is presented to the program receiving device as a picture-in-picture panel.

16. The computer program product of claim 15, further comprising instructions for implementing:
associating the content preview and the picture-in-picture component of the onscreen programming guide with a panel of the programming receiving device to enable the picture-in-picture panel to be displayed within the panel of the onscreen programming guide at the program receiving device.

17. The computer program product of claim 15, further comprising instructions for implementing:
providing audio with the content preview within the picture-in-picture panel; and
decreasing the volume of a program that is presented in a program viewing panel of the program receiving device, the volume of the program in the program viewing panel decreased to a level that is lower than the volume of the content preview.

18. The computer program product of claim 15, further comprising instructions for implementing:
updating content presented to the picture-in-picture panel to reflect selection of another program descriptor, the updated content including a content preview associated with the other program descriptor.

19. The computer program product of claim 14, wherein the content preview panel is presented to a program receiving device that is Internet Protocol network-enabled and comprises at least one of a:
television;
personal computer;
personal digital assistant;
digital audio player; and
cellular telephone.

20. The computer program product of claim 14, wherein the information about the program includes at least one of:
a commercial;
movie trailer;
static image;
sound bite;
content sample; and
a series of still images.
